(19) United States
(12) Patent Application Publication
(10) Pub. No.: US 2010/0000426 A1
(43) Pub. Date: Jan. 7, 2010

(54) APPARATUS FOR PRINTING CHARACTERS ON A COMPUTER KEYBOARD AND METHOD THEREOF

(75) Inventor: HUO-LU TSAI, Ta Ya Shiang, Taichung Hsien (TW)

Correspondence Address: G. LINK CO., LTD., 3550 BELL ROAD, MINOKA, IL, 60447, US

(73) Assignee: Sunrex Technology Corp., Taichung Hsien (TW)

(21) Appl. No.: 12/487,040

(22) Filed: Jun. 18, 2009

(30) Foreign Application Priority Data
Jul. 3, 2008 (TW) 097211787

(51) Int. Cl. B41F 17/00

(52) U.S. Cl. 101/41

(57) ABSTRACT

Apparatus and method for printing characters on a computer keyboard are provided. The apparatus includes a padding film disposed above a keyboard blank having a plurality of keys, the padding film including a plurality of different characters; and a printing press disposed above the padding film and comprising a plurality of projecting typing heads formed on a bottom, wherein the printing press, the padding film, and the keyboard blank are aligned vertically; and whereby lowering the printing press to push the padding film until the padding film contacts the keyboard blank, and causing the printing press to press the padding film so as to print the characters on the keys by heating, and lifting the printing press will produce the finished computer keyboard.

### BACKGROUND OF THE INVENTION

1. Field of Invention

The invention relates to the manufacturing of computer keyboards and more particularly to an apparatus for printing characters on keys of a computer keyboard and method therefor with improved characteristics.

2. Description of Related Art

Taiwanese Publication Application No. 496,829 discloses an apparatus and method for printing characters on a computer keyboard. The method comprises the steps of coating an adhesive material on keys of a computer keyboard blank, pressing a printing press on the keys of the computer keyboard blank to form characters thereon, and cooling the computer keyboard blank to produce the finished computer keyboard with characters printed thereon.

Further, the invention described later is an outgrowth of earlier work by the inventor hereof, described in Taiwanese Utility Model Patent No. M323,075, entitled “Transparent Color Computer Keyboard”. The computer keyboard is produced by coating a transparent, adhesive color material on keys of a computer keyboard blank, coating an opaque adhesive material on the transparent, adhesive color material, using a laser device to remove the opaque adhesive material on the corner portions of the keys of the computer keyboard blank by etching to expose characters on the four corners of the keys of the computer keyboard blank, applying a transparent protective adhesive material on the keys of the computer keyboard blank, and cooling the computer keyboard blank to produce the finished computer keyboard (i.e., transparent color computer keyboard) with characters printed thereon.

However, the well known laser device for etching is very expensive. Further, it can complicate the manufacturing processes. Thus, the need for improvement still exists.

### SUMMARY OF THE INVENTION

It is therefore one object of the invention to provide an apparatus for printing characters on a computer keyboard, comprising a padding film disposed above a keyboard blank having a plurality of keys, the padding film including a plurality of different characters; and a printing press disposed above the padding film and comprising a plurality of projecting typing heads formed on a bottom, wherein the printing press, the padding film, and the keyboard blank are aligned vertically; and whereby lowering the printing press to push the padding film until the padding film contacts the keyboard blank, and causing the printing press to press the padding film so as to print the characters on the keys by heating, and lifting the printing press will produce the finished computer keyboard.

It is another object of the invention to provide a process for printing characters on a computer keyboard, comprising the steps of aligning a padding film with a keyboard blank therebelow wherein the keyboard blank includes a plurality of keys, and the padding film includes a plurality of different characters; aligning a printing press with the padding film therebelow wherein the printing press includes a plurality of projecting typing heads formed on a bottom; lowering the printing press to press the padding film on the keyboard blank to print the characters on the keys by heating; and lifting the printing press will produce the finished computer keyboard.

The above and other objects, features and advantages of the invention will become apparent from the following detailed description taken with the accompanying drawings.

### BRIEF DESCRIPTION OF THE DRAWINGS

FIG. 1 is an exploded view of an apparatus for printing characters on a computer keyboard according to the invention;

FIG. 2 is a fragmentary view of FIG. 1;

FIG. 3 is a view similar to FIG. 2 where the printing press has been removed by lifting and the releasable layer has been removed by peeling after printing;

FIG. 4 is a schematic longitudinal sectional view of FIG.1;

FIG. 5 is a view similar to FIG. 4 where the printing press has been moved to press the padding film which in turn presses the keyboard blank;

FIG. 6 is a view similar to FIG. 5 where the printing press has been removed by lifting and the releasable layer has been removed by peeling after printing;

FIG. 7 is a detailed view of the area in circle A in FIG. 6; and

FIG.8 is a flowchart depicting a process for printing characters on a computer keyboard according to the invention.

### DETAILED DESCRIPTION OF THE INVENTION

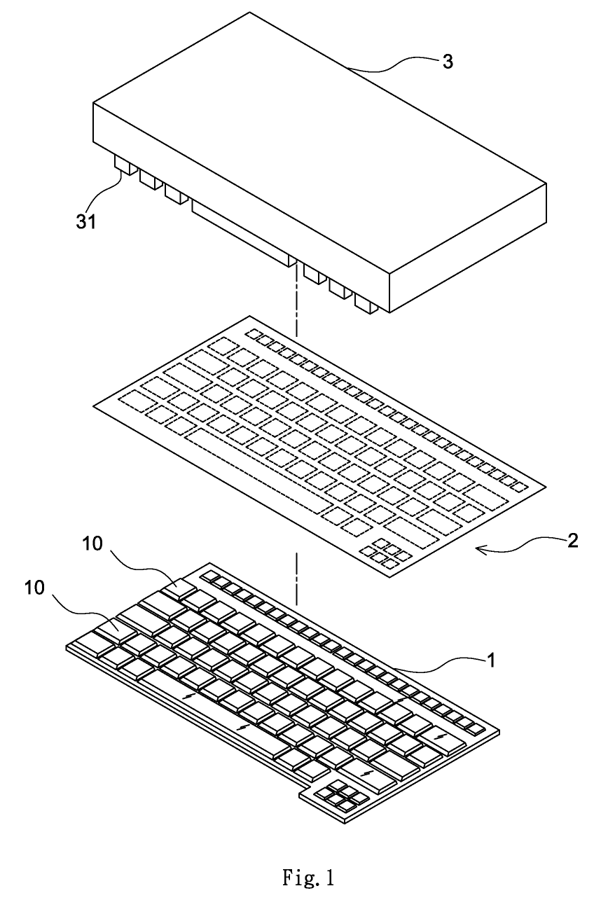

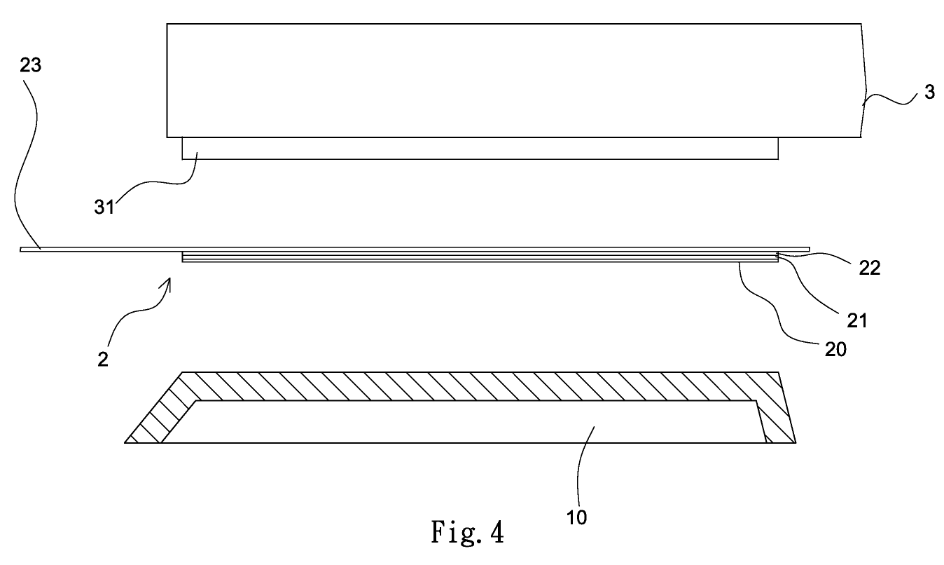

Referring to FIGS. 1 to 7, an apparatus for printing characters on a computer keyboard in accordance with the invention is shown. The apparatus comprises the following components as discussed in detail below.

A keyboard blank 1 having a plurality of (e.g., 104) keys 10 is positioned on a press bed (not shown). A thin, rectangular, planar padding film 2 shaped as a top of a computer keyboard is positioned above the keyboard blank 1 by a holding device (not shown). A printing press 3 is disposed above the padding film 2 and comprises a plurality of spaced, projecting typing heads 31 formed on a bottom. The number of the typing heads 31 is equal to that of the keys 10. The printing press 3, the padding film 2, and the keyboard blank 1 are aligned vertically (see FIG. 1).

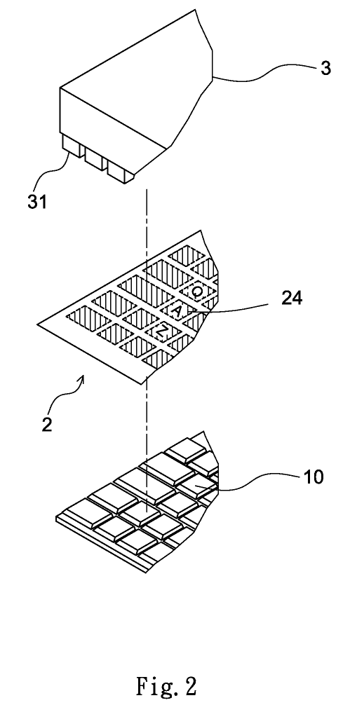

A plurality of spaced rectangles (indicated by dash lines) 24 are formed on the padding film 2 and are aligned with the typing heads 31 respectively. Also, the rectangles 24 are aligned with the keys 10 respectively. Each rectangle 24 is provided with a unique character (e.g., “Q”, “A”, or “Z” as shown in FIG. 2). The padding film 2 comprises, from bottom to top, a primer 20, a character layer 21 formed on the primer 20 wherein characters of the character layer 21 are aligned with the rectangles 24 respectively, a protective layer 22 formed on the character layer 21, and a releasable layer 23 temporarily formed on the protective layer 22 by means of adhesive.

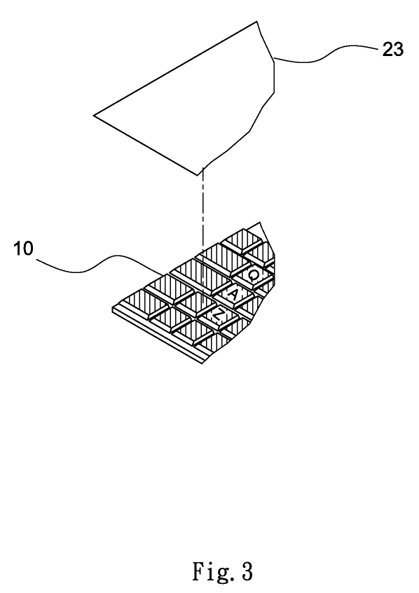

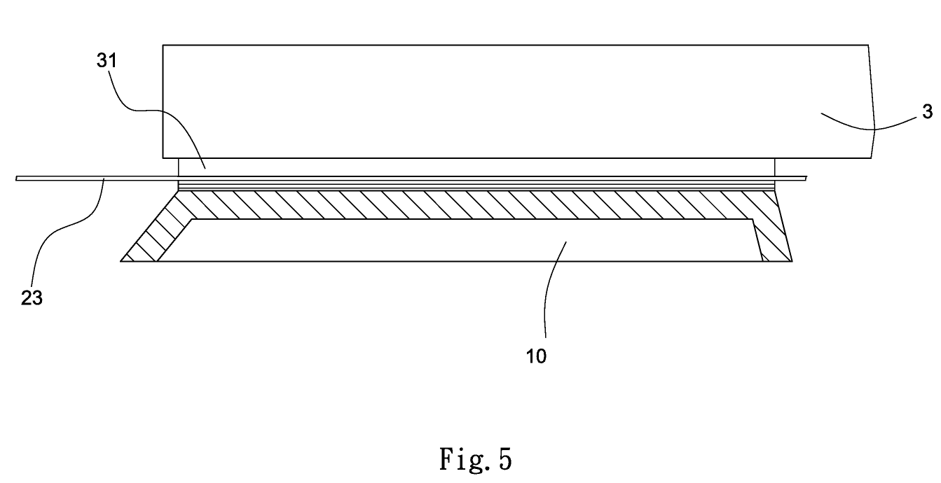

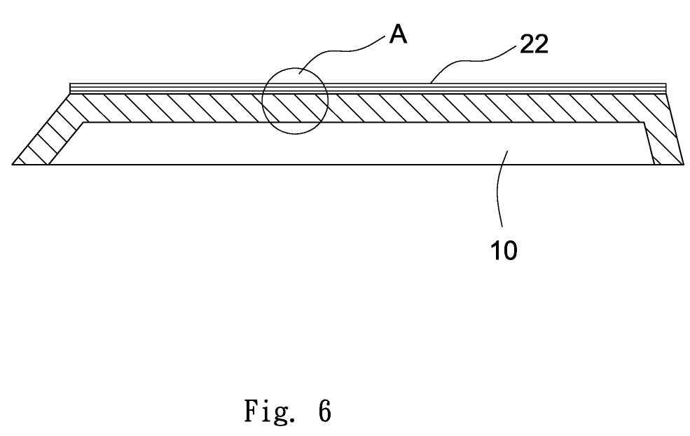

As shown in FIG. 5 specifically, the printing press 3 is activated to move downward after aligning with both the padding film 2 and the keyboard blank 1 therebelow. The typing heads 31 will push the padding film 2 to contact the keyboard blank 1 after contacting the padding film 2. And in turn, the padding film 2 as pressed by the printing press 3 precisely prints the characters on the keys 10 by heating. Thereafter the printing press 3 is removed by lifting and the releasable layer 23 is also removed by peeling (see FIG. 3). As a result, a computer keyboard having a plurality of keys 10 each with a unique character formed thereon is produced (see FIG. 6).

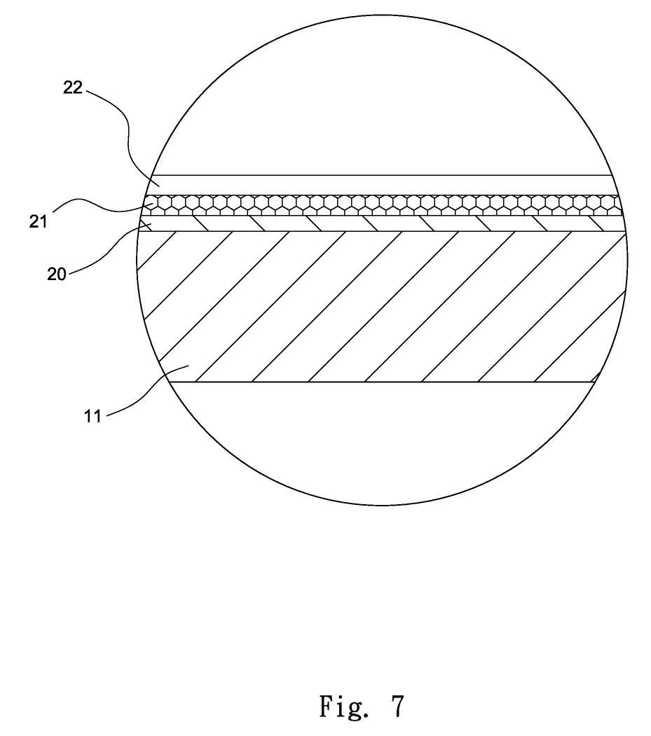

As shown in FIG. 7 specifically, the primer 20, the character layer 21, and the protective layer 22, from bottom to top, are formed on a top layer 11 of the key 10. It is understood that the characters printed on the keys 10 are protected.

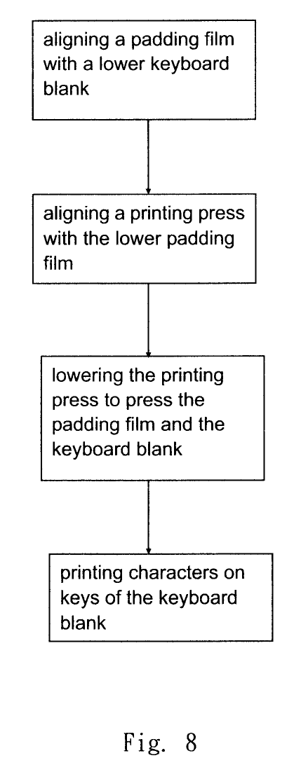

Referring to FIG. 8, a process for printing characters on a computer keyboard according to the invention is illustrated. The process comprises the steps of aligning a padding film with a keyboard blank therebelow, aligning a printing press with the padding film therebelow, downward moving the printing press to press the padding film on the keyboard blank and printing characters in the padding film on keys of the keyboard blank by heating, and lifting the printing press and peeling a releasable layer from the keys of the keyboard blank, thereby producing a computer keyboard having a plurality of keys each with a unique character formed thereon.

While the invention herein disclosed has been described by means of specific embodiments, numerous modifications and variations could be made thereto by those skilled in the art without departing from the scope and spirit of the invention set forth in the claims.

What is claimed is:

1. An apparatus for printing characters on a computer keyboard, comprising:
a padding film disposed above a keyboard blank having a plurality of keys, the padding film including a plurality of different characters; and
a printing press disposed above the padding film and comprising a plurality of projecting typing heads formed on a bottom,
wherein the printing press, the padding film, and the keyboard blank are aligned vertically; and
whereby lowering the printing press to push the padding film until the padding film contacts the keyboard blank, and causing the printing press to press the padding film so as to print the characters on the keys by heating, and lifting the printing press will produce the finished computer keyboard.

2. The apparatus of claim 1, wherein the padding film comprises a primer, a character layer with the characters disposed therein, the character layer being formed on the primer, a protective layer formed on the character layer, and a releasable layer releasably formed on the protective layer.

3. The apparatus of claim 1, wherein the number of the typing heads is equal to that of the keys and is equal to that of the characters respectively.

4. A process for printing characters on a computer keyboard, comprising the steps of:
aligning a padding film with a keyboard blank therebelow wherein the keyboard blank includes a plurality of keys, and the padding film includes a plurality of different characters;
aligning a printing press with the padding film therebelow wherein the printing press includes a plurality of projecting typing heads formed on a bottom;
lowering the printing press to press the padding film on the keyboard blank to print the characters on the keys by heating; and
lifting the printing press will produce the finished computer keyboard.
